(19) United States
(12) Patent Application Publication
(10) Pub. No.: US 2013/0209968 A1
(43) Pub. Date: Aug. 15, 2013

(54) LESSON BASED DRIVER FEEDBACK SYSTEM & METHOD

(71) Applicants: Peter Miller, Sussex (GB); Eric Anthony Chan, Cambridgeshire (GB)

(72) Inventors: Peter Miller, Sussex (GB); Eric Anthony Chan, Cambridgeshire (GB)

(73) Assignee: RICARDO UK LTD, Sussex (GB)

(21) Appl. No.: 13/820,466

(22) PCT Filed: Sep. 1, 2011
(86) PCT No.: PCT/GB2011/051642

§ 371 Date: May 2, 2013

(30) Foreign Application Priority Data
Sep. 1, 2010 (GB) 1014497.0

(51) Int. Cl. G09B 19/16

(52) U.S. Cl. CPC G09B 19/167
USPC 434/65

(57) ABSTRACT

A feedback and training system for use in a vehicle the vehicle comprising or connected to one or more sensors enabled to measure one or more physical parameters associated with the vehicle; the system comprising a database, configured to receive and store data from the sensors, a processor enabled to calculate at least one performance factor based at least partly on the current physical parameters measured from the one or more sensors, a display configured to display to a driver representations of one or more of the performance factors, wherein the calculation of a performance factor, or the timing of or the prominence given to the display of the representation of a performance factor, is dependent on historic sensor data stored in the database received previously from the sensors.

### TECHNICAL FIELD

The present invention relate to a method and apparatus for providing feedback to a driver about their driving. In particular, the invention provides the driver with more accurate and relevant information regarding their driving and identifies and displays training to improve the driving.

### BACKGROUND TO THE INVENTION

It is known in vehicles to provide real-time information which is designed to help the user improve efficiency. For example, in-car feedback systems exist which indicate to the driver when to change gear in order to improve fuel efficiency. Other systems exist which inform the driver of their fuel consumption whilst driving. Such systems typically rely on real-time information that is collected whilst a vehicle is being driven.

However, such systems are often basic in nature and because of their real-time nature may not provide the most accurate data. For example, fuel consumption is typically calculated on the conditions at a given moment. However, this may not necessarily be a true reflection of a driver's consumption. For example, if the road conditions required a lower gear than would otherwise be used then the fuel consumption for that particular stretch of road may increase.

Furthermore, the values determined are not necessarily an accurate reflection of the true value. For example fuel consumption is typically determined with reference to a “golden car” or test car. Prior art systems do not take account of the differences between an actual car's behaviour and the test car when determining fuel consumption. Therefore, a value determined for fuel efficiency may in fact be different to the actual value.

A further consideration is that it is often undesirable to present a user with large amounts of information. This is particularly an issue if the user is presented with the information whilst they driving as it may lead to distractions and display of too much information may prevent the driver from being able to assimilate the most important information sufficiently quickly.

It is also known to attempt to influence driver behaviour through the use of audio and/or visual cues. Such cues may be used to indicate to the driver to change gear, for example. As stated above it is an important consideration that these cues do not distract the driver by presenting the driver with too much information. Furthermore, the rate of information and the information presented to the driver is important. If the same information is constantly repeated then the user is likely to find this irritating and may switch off the device presenting the information. If information is presented at a rate that is too fast, the user may be distracted, and too slowly the user may not be interested. Further no system is able to make judgements on as full a range of observations and criteria as a human driver. For example a gear change indicator based on engine revolutions, throttle level and current speed may determine that the driver should move up one or more gears whereas the driver may know that they will shortly need to overtake a vehicle and that the relatively low gear will be required. Because the gear change indicated will not always be suitable its constant presence can be an annoyance and a distraction.

Present systems output information based on current real time indicators independent of the particular driver and their present level of skill. Information that may be of great use to a highly skilled driver may not be shown as it may be known to distract less skilled drivers who are unable to make use of it.

There also exist systems which signal to the operator of a fleet of vehicles if a driver is driving erratically such as by comparing their current driving to the normal driving profile for that driver. These systems do not present information to the driver themselves in a manner that can be effectively used to improve their driving or led to a more effective man machine driving interface with the vehicle.

### SUMMARY OF THE INVENTION

To mitigate, and potentially solve, at least some of the above problems in the prior art there is provided a system for monitoring driver behaviour and feeding back to the driver via an in-car HMI (human-machine-interface) or via a separate application that the driver can access through a network, such as the internet. The feedback is preferably in the form of training so that the driver is able to identify their errors and improve their driving.

There is also provided a mechanism for the system to provide vehicle feedback in order to better determine any number of vehicle operating parameters or performance factors, such as fuel consumption, optimal gear changing pattern, optimal gear etc.

According to a first aspect of the invention there is provided a feedback and training system for use in a vehicle: the vehicle comprising or connected to one or more sensors enabled to measure one or more physical parameters associated with the vehicle; the system comprising a database, configured to receive and store data from the sensors, a processor enabled to calculate at least one performance factor based at least partly on the current physical parameters measured from the one or more sensors, a display configured to display to a driver representations of one or more of the performance factors, wherein the calculation of a performance factor, or the timing of or the prominence given to the display of the representation of a performance factor, is dependent on historic sensor data stored in the database received previously from the sensors.

Preferably wherein at least one, and preferably each, performance factor is primarily or wholly indicative of current vehicle performance; and/or wherein the calculation of a performance factor, or the timing of, or the prominence given to, the display of the representation of a performance factor is dependent on prior journey historic sensor data stored in the database received from the sensors during previous journeys to the current measured physical parameters.

According to an aspect of the invention there is provided a feedback and training system for use in a vehicle: the vehicle comprising or connected to one or more sensors enabled to measure one or more physical parameters associated with the vehicle; the system comprising a database, configured to receive and store data from the sensors and comprising a plurality of items/sets of training data, a processor, and a display configured to display to a driver; the processor configured to calculate or select driver training data from the sets/items in the database, the system configured to display the calculated or selected training data on the display.

Preferably wherein the processor is configured to determine the relevancy of a plurality of different training data in the database, preferably the relevance to the currently identified driver, and display the most relevant training data, wherein the relevancy is determined by one or more of: historical sensor data, and occurrence of previous training data being displayed.

Further aspects, features and advantages of the present invention will be apparent from the following description and appended claims.

### BRIEF DESCRIPTION OF THE DRAWINGS

An embodiment of the invention will now be described by way of example only, with reference to the following drawings, in which:

FIG. 1 is a schematic diagram of apparatus in accordance with the invention;

FIG. 2 is a flow chart of a process of using vehicle feedback in order to provide information to a user via a performance factor;

FIG. 3 is a flow chart of a process of providing a user with training based on their driving;

FIG. 4 is a schematic of an HMI in accordance with the invention;

FIG. 5 is an image from a front facing camera; and

FIG. 6 is an image from a UK government driver awareness campaign used in by an embodiment of the invention.

### DETAILED EMBODIMENT

According to an aspect of the invention there is provided a system for use in a vehicle that is enabled to provide feedback to a user based on their driving of the vehicle. In the present description the invention is described with reference to a motor-car though at least some of the concepts described herein are applicable to other types of vehicles such as lorries, motorbikes, boats, trains, aeroplanes etc. The user is taken to be the person in control of the vehicle i.e. the driver.

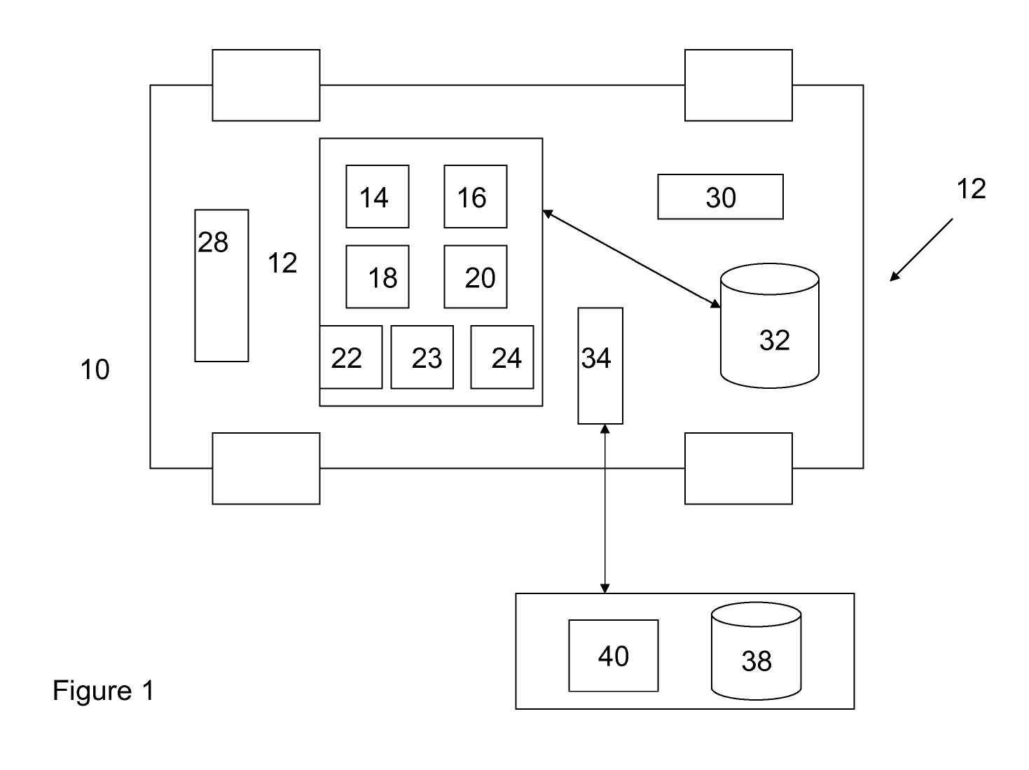

FIG. 1 shows a schematic representation of a system 8. The system 8 comprises vehicle 10; array of sensors 12 connected to the vehicle 10, a human-machine interface (HMI) 28; in car processor 30; in car database 32; wireless communication means 34; external server 36, the external server 36 comprising a database 38 and processor 40.

The vehicle 10 is a known vehicle to which an array of sensors 12 has been fitted or which were already present and accessed by the HMI 28, database 32/38 and/or processor 30 by a conventional Onboard Diagnostics Port (OBD). The sensors 12 may be known commercially available sensors which are enabled to measure a number of physical parameters associated with the vehicle 10. Such sensors may include fuel sensor 14; accelerometer 16; tachometer 18; speedometer 20; gear sensor 22; front facing camera 23, a trip meter 24, global positioning system (gps) and radar (both not shown). The list of sensors is non-exhaustive and may vary depending on the vehicle and what is being measured. For example, an aeroplane would typically contain airspeed sensors which would not be needed for ground-based vehicles.

The sensors 12 are preferably digital sensors and the information from the sensors is communicated to a form of memory/electronic storage such as a database. The database may be an in-car database 32, an external database 38 or both. If an external database 38 is used wireless communication means 34, such as a GPRS device or other cellular radio device can be used to communicate sensor information to the external database 38. The HMI 28 may be in the form of a smartphone or cellular radio equipped tablet computer and therefore will include the communication means 34. A combination of cellular radio and other wireless communications (such as WiFi) can be used with more data intensive sensors such as a video camera 23 sending data by the means with highest bandwidth and other sensors sending data by way of the most regularly connected means.

As well as direct communication, methods involving a person my be used. For example the information may be stored in situ on a USB connected flash memory device which is physically transported by the driver and connected to a computer external to the car to allow uploading to the external database 38.

Information is displayed to the user via an HMI 28. The HMI 28 contains a graphical interface which can display information to a user and is further associated with an audio output. Preferably the HMI 28 has an associated input device, such as a touch screen. The HMI 28 is driven in part by the in-car processor 30 and/or external processor 40. As described below the HMI 28 may be combined with other known in car technologies such as GPS based satellite navigation system.

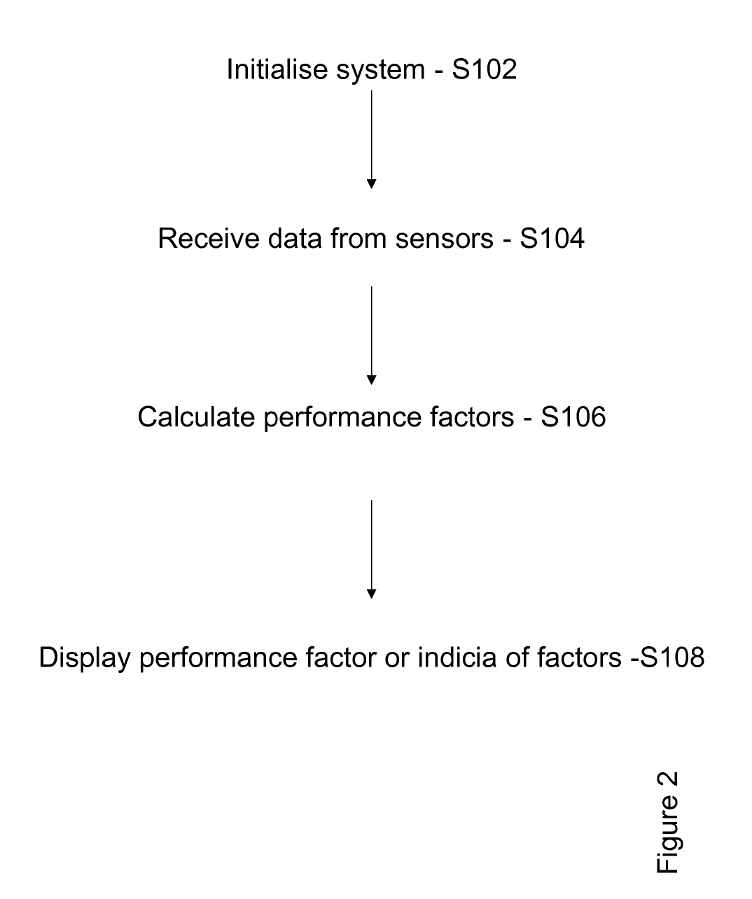

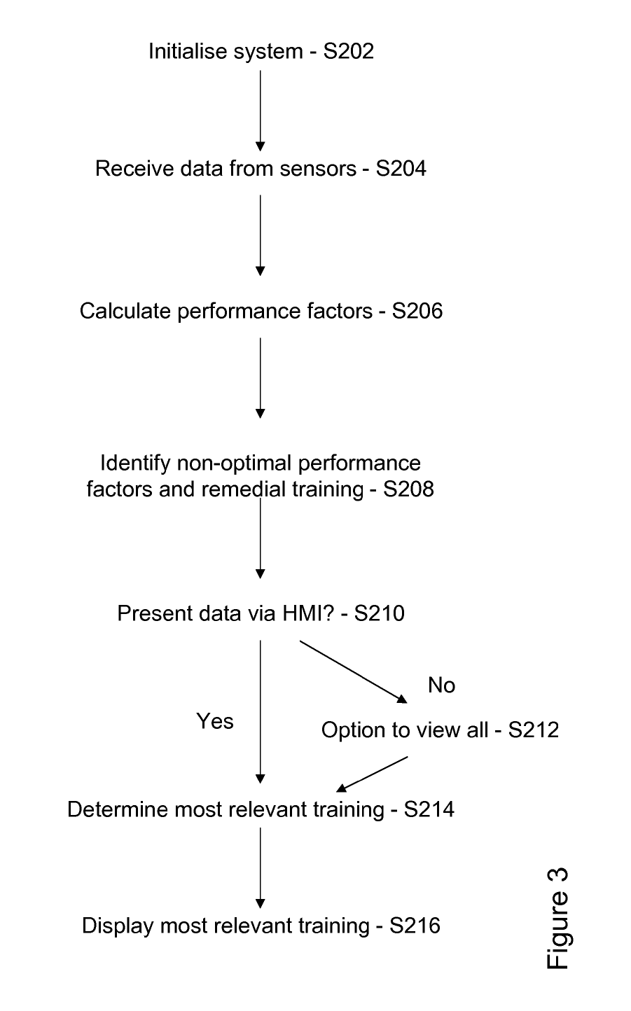

The collection of data from the sensor array 12, subsequent analyses and display of information on the HMI 28 is discussed in detail with reference to FIGS. 2 and 3.

FIG. 2 is a flow chart of a process of using vehicle based feedback to provide a performance factor to the user so that they can analysis and adjust their driving.

The term performance factor is used to indicate a factor that is affected by how a car is being driven. An example of a performance factor is fuel consumption expressed as miles per gallon. A user who is driving conservatively will tend to drive more miles per gallon than one who drives aggressively. Other examples of a performance factor include gear selection, where the wrong choice of gear can increase fuel consumption and control of the car; rate of acceleration/deceleration etc.

Typically, in prior art systems the performance factor is determined using predetermined model data which may not accurately reflect the conditions within the vehicle. To better reflect the actual conditions within the vehicle, vehicle based feedback performance factors are calculated, and if desired the performance factor may be subsequently presented to the user.

At step S102 the system initialises. This may be as a result of the engine starting in the vehicle or selecting an option on the HMI 28. If the system is in contact with an external server 36, preferably the wireless communication means 34 initiates contact with the server 36 using known handshake protocols to identify and authenticate the user and/or vehicle 10. In the external server 36 embodiment, the external server 36 may collect and process data for a number of vehicles 10. If data is collected for a plurality of vehicles, the data is preferably identified as originating from a particular vehicle by a Universal Unique Identifier (UUID) or similar.

In a further embodiment, the user may select which performance factor(s) they wish to monitor at the HMI 28.

Once the system is initialised at step S102, at step 104 the array of sensors 12 collects data regarding the vehicle 10. In an embodiment, in order to reduce energy consumption only the sensors that are required to measure the desired performance factors, as selected at step S102, collect data. Preferably, to maintain an accurate dataset, data is sampled frequently and time-stamped. The frequency of data sampling may depend on the type of data collected, for example the accelerometer 16 may sample data at a relative high rate in order to capture short sharp accelerations that may occur when driving (e.g. when overtaking or moving from a stationary position). In the case of the on board camera 23 it will normally be used continuously with an entire video of the journey being stored in the database. The resolution of the video (and of the camera) chosen may then be dictated by the amount of memory available locally and externally as well as the level of detail that it is useful to analyse.

Once the data has been sampled at step S104 it is stored locally within the vehicle 10 in the in-car database 32 and/or on the external database 38. If the data is stored on the external database 38 the data is transmitted using the wireless communication means 34 (or manually after the journey using a USB flash memory device).

Therefore, the database contains information collected during the course of a journey. Preferably, the database also contains information from previous journeys for which data has been collected.

At step S106 the performance factor is calculated using the data collected at step S102 and the historic data already stored in the database(s) 32, 38. The performance factor may be calculated in “real-time” that is to say updated upon receipt of further data at step S104 or it may be calculated at set intervals e.g. a time interval or at the end of a journey, whilst the vehicle 10 is idling etc.

An advantageous aspect of the invention is that the historical data is also used to affect the calculation of the performance factor and this generally allows for a more accurate determination of a given performance factor. For example, if the performance factor of fuel consumption in miles per gallon were chosen, the historical data could be used to determine precisely the distance travelled and the actual fuel consumption at least between episodes of refuelling. As well as historical data from sensors the historical data may include manually input data via the HMI 28. For example every time a diver refuels, they may input how many litres have been added to the fuel tank and this will be sent to the database 38 along with other data such as the number of miles driven since the vehicle was last refuelled etc.

Furthermore, in periods of steady speed (for example when on a motorway) the actual fuel consumption at a given speed e.g. 60 mph, may be determined rather than using the value calculated for a test car. An advantage of the use of historical data is that performance factors can not only be recalculated at a later stage using the data accumulated during a journey but their present values can be more accurate. For example, if measurement of total miles driven between episodes of refuelling in the historical data reveal that the miles to the gallon of this particular car is regularly lower than that expected based on the “golden car” the algorithms used for real time calculation of the fuel consumption performance factor can be adjusted to reflect this and therefore show lower values than if the historical data had not been used. As another example the historical data from the tachometer 18 and gear sensor 20 can be used to determine the manner in which performance in different gears at after gear changes varies from the “golden car” and used to adjust the algorithms used for real time calculation of the gear selection performance factor. This could therefore result in gear changes being displayed slightly earlier or later or even the gear chosen to be optimum that is displayed to the driver to be different better reflecting the actual performance of the car.

Instead of strict “golden car” algorithms the algorithms may be based on manually input data. For example initial fuel consumption algorithms before modification based on historical data may be based on input engine type, vehicle manufacturer details on fuel consumption and approximating to the vehicles' brake specific fuel consumption map.

Once the performance factor has been calculated, the factor is displayed to the user at step S108. The performance factors can either be presented to the user via the HMI 28 or accessed by the user via a webpage or mobile telephone application.

Preferably, information which is calculable in real-time is presented to the user via the HMI 28 to allow them to analysis their driving. Information presented via the HMI 28 may be presented via a visual indicator such as an icon so as to not to overload the user with information whilst they are driving. Such indicia of the HMI 28 may vary according to user preference.

In a further embodiment, separately or in addition to, the performance factors and other recorded data may be accessed by the user, or another person, via a computing device. Such access may occur via a website where the user can login and access their data using known login techniques, or via a mobile telephone application where data is accessed via a mobile telephone. In such an embodiment, as the user is not in control of a vehicle they may be presented with more detailed information regarding the calculated performance factors.

FIG. 3 shows a flow chart of another aspect of the invention, the identification and presentation of training data in order to improve driver behaviour.

The steps of initialising the training system step S202, collecting of the data from the sensors step S204 and calculation of the performance factors step S206 are as described for the same steps in FIG. 2.

In addition to determining performance factors the invention is enabled, at step S208, to identify non-optimal behaviour/performance factors and training that the user can undertake to improve their driving. In an embodiment, the database contains a number of predetermined optimal performance factors and the processor compares the determined performance factor with the optimal factor. If the determined performance factor differs from the optimal by more than a predetermined amount then training may be offered to the user to improve the performance factor. For example the fuel consumption should be too high or the driver could be changing gear too late/early or regularly driving in a different gear to that deemed correct by the gear selection performance factor.

The training is offered in the form of a training program which is stored in the database 32 38, or in a separate database (not shown). Preferably for each performance factor one or more different training programs can be offered to improve the performance factor.

For example, if the performance factor is fuel consumption/mpg then training to improve fuel consumption may include information on optimal gear changing patterns, optimal “cruising” speed etc.

The training program may be offered in the form of some text or video (e.g. describing what are the optimal speeds for fuel consumption), audio and/or visual prompts for when to perform certain actions (e.g. a change of gear), audio and/or visual prompts to indicate a desired range (e.g. an optimal speed). Whilst driving any output information is chosen to be non-distracting such as the speed limit sign if the driver is exceeding the speed limit. When not driving—either via the HMI 28 or a website the output may include suitable video from the front facing camera 23 which demonstrates driver error and can be contrasted with existing archive footage of good driving practice and/or overlaid with indications of what should have been done. When a gps unit is used as one of the sensors, information from other sensors 12 can be tagged with their geolocation and stored in the databases 32, 38 with this location tag enabling historic sensor data to be retrieved based on location. So for example where information in the databases 32, 38 from the gear sensor 22 or accelerometer 16 suggests user error, the location of those error can be determined and the video from the front facing camera 23 also corresponding to that location can be retrieved which as may therefore include footage relating to the error and can be used ion the manner described above.

It is normally preferable not to present all the possible training that is available to a user. For example, if the user is presented with the same training program repeatedly they may loose interest and disable the system. Similarly, if the user is presented with the training whilst driving on the HMI 28 (see below) then it is undesirable to present the user with certain types of training (e.g. video), or information if this could distract the user. Therefore, the most relevant training program and the information to be shown to the user need to be determined.

At step S210 the system determines if the information is to be presented by a website or mobile telephone application.

If the user wishes to access their training program via a website or mobile telephone application, then the process goes to step S212. As the user is not in control of a vehicle at step S212 then they may be presented with more in-depth information. Consequently, the user may be given the option to view all available training at step S212.

At step S214 the most relevant training program for the user is determined. As there may be several possible training programs for each performance factor, and the user may potential have several non-optimal performance factors the system may identify several possible training programs at step S208. In order to determine which is the most relevant of the programs historical driver data as stored in the database is used. For example, if a user has a history of performing poorly for a given performance factor (e.g. fuel consumption) but is showing improvement from previous data then it may not be desirable to constantly present the user with training to improve fuel consumption. Conversely if the historical user data shows that a user's performance factor has decreased then it would be desirable to present them with training on how to improve the performance factor.

In a preferred embodiment, each performance factor is assigned a weighting. The difference between the determined performance factor and the optimal performance factor is assigned a weighting. Large differences between the determined performance factor and the optimal factor, which would indicate the need for some training, are assigned a higher weighting than small differences. Furthermore, the user may manually weight the factor to indicate their preference. For example, if a user is particularly interested in improving fuel consumption and they indicate that this of particular interest, for example, via the HMI 28 or website, then training programs relating to fuel consumption are assigned a more favourable weighting. Conversely, if the user indicates that they have little interest in fuel consumption then the same programs would have a less favourable weighting. The weighting factor is also dependent on historic performance (as discussed above) with an increase in a performance factor leading to a decrease in the weighting and vice versa, and which programs have been previously presented to the user. It is found that presenting the same information repeatedly to a user may be less effective as the user loses interest. Programs with the highest weighting are subsequently presented to the user at step S216.

At step S216 depending on the means for displaying the training (HMI 28 or website/mobile telephone application) the most relevant training is displayed. Though as stated above, if the user is accessing the training via a website or mobile telephone application they are given the option viewing all training.

As well as the training selection being based on individual differences from optimal performance factors the training available may be graded based on difficulty and the selection also based on a holistic assessment of driver skill. A total score for driver skill can be calculated based on all differences from performance factors and based on this score training at the relevant difficult level may be selected.

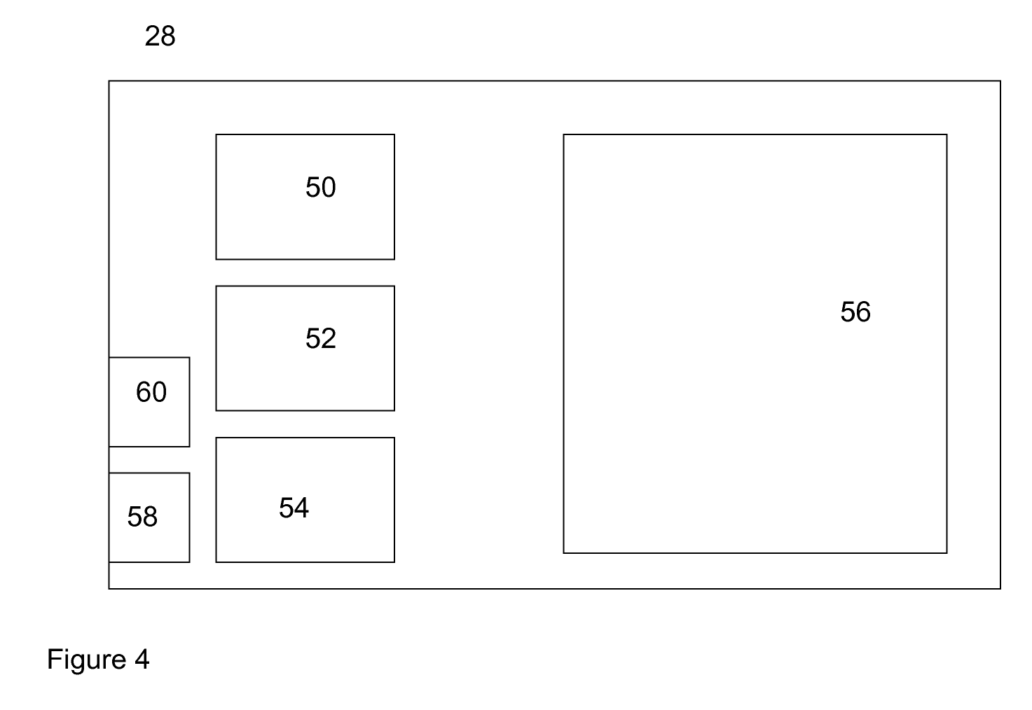

If the user is viewing the training via the HMI 28, as in-car training, then certain parts of a the training program may not be appropriate e.g. text and/or video. Accordingly, depending on the means for viewing the training information the user may receive different information. If the training is viewed via the HMI 28, the user typically receives audio and/or visual prompts to perform certain actions at a given time whilst driving. They may also receive a summary at the end of a journey. Depending on the relevancy of the training data, the size of the presentation of the data on the HMI 28 may also vary (see FIG. 4).

The rate at which they receive the training information is also variable. If the user is presented with too much information then they may find it overwhelming and possibly distracting. Similarly, if the rate of information is too slow then it is likely that the user may not be interested and accordingly ignore the prompts. Accordingly the rate at which different training is displayed can be adjusted based on the rate of improvement in the drivers skill based on their recorded performance by the sensors (such as the holistic score mentioned above).

FIG. 4 is an example of a HMI 28 used to display the calculated performance factors and training data.

There is shown the HMI 28, comprising various performance factor indicators 50, 52, 54, training data indicator 56, and user inputs 58, 60.

In the example shown in FIG. 4 the HMI 28 has four indicators and two user inputs though in other embodiments the number of indicators and user inputs may change.

In the example shown the indicators 50, 52, 54, may show various indicators of the calculated performance factors. For example indicator 50 could show optimal gear, indicator 52 optimal speed and indicator 54 fuel consumption. The performance factor can be shown as an absolute numerical value or an indicator that the user may understand (e.g. a red light for high fuel consumption).

Depending on the historical data of the driver one or more of the indicators may be turned off at a given moment thereby reducing the number of indicators shown to a user at a given time. Furthermore, the size of the indicators shown in FIG. 4 is not limiting. In a further embodiment, the size of the indicators may increase or decrease according to historical data. For example for a driver with historical data that shows that they are very good at choosing the same gear as indicated by the relevant performance factor and for changing gear at the right time, the indicator relating to gear selection may be deactivated or made smaller. As described above as the system 8 can not analyse as many factors as a human driver its gear selection will not always be appropriate. Accordingly have a large prominent gear selection indicator for a driver who is demonstrably good at choosing the right gear may distract them from information that could be of use to improve their driving in particular to improve fuel efficiency. The holistic driver score may also be used in the selection of which indicators are displayed and which displayed most prominently.

Additionally some indicators may only be shown if the present performance differs from the ideal value of performance factor by more than a set threshold. The level of the threshold may be adjusted depending on the drivers skill level in regard to other performance factors. For example if a driver shows a low level and skill and understanding of the performance factors has a low threshold on all performance factors it would result in them being inundated with constant visual cues at a rate they could not process. Accordingly where the driver is regularly far away from optimal driving large thresholds may be put in place with those performance factors that are believed to be easier for basis drivers to address given relatively lower thresholds (and/or displayed more prominently/with increased size) than those that are considered to only be of much use to advanced drivers. For an advanced driver who is rarely far away from the optimum calculated performance the threshold might be small since even then they will not be presented with much information.

If training data is presented to the user, this may be shown in the training data indicator 56. Depending on user preference there may a single training data indicator 56 or a plurality of indicators. As with the performance factor indicators the size of the training data indicator 56 as shown in FIG. 4 is not limiting with the training data indicator 56 been enabled to be sized according to user preference, the relevancy of the training data presented, to historical sensor data or on what training has already been presented to this driver.

Preferably, the HMI 28 also contains a plurality of user inputs 58 60 allowing the user to navigate the HMI 28. Such inputs may be known inputs such as buttons or a touch screen.

Preferably, the HMI also contains an audio output (not shown) to allow for audio cues. This is particularly useful in training data where audio cues can be used to indicate to a user that an event should occur (e.g. a change of gear).

Therefore, the present invention provides a method and system for using information collected from a vehicle in use to optimally determine a number of performance factors. These performance factors can also be used to identify training which the driver can undertake (either whilst driving through prompts from the HMI 28, or from information presented at a website or mobile telephone application). The system is also enabled to identify which training is the most relevant to the user and show only the most relevant information in order to prevent the user being overwhelmed and possibly distracted.

HMI 28 can also incorporate conventional satellite navigation. Many drivers are now accustomed to viewing satellite navigation and listening to audio instructions from it whilst driving. Accordingly by displaying visual performance factor indicators 50, 52, 54, training data indicator 56 along side or on top of navigation information the driver can easily take in the relevant information without having to look in multiple places. Audio cues from system 8 can also be synchronised with audio instructions for navigation to ensure that they do not play over each other and so that the user can take in all the information.

The navigation information can also be fed to the processor 30 together with the data from the sensor array 12 and used in the calculation of performance factors at step S106. For example knowledge of routes, maximum speeds and altitude gradients can be used for fuel consumption calculations. Information regarding locations of junctions and roundabouts can also be used both in the calculation of the performance factor for gear selection and in the analysis of whether the driver has been making the right gear selections in historical data. In the historical data the navigation information can also be checked against sensor information regarding speed and/or direction—so that inaccuracies in the navigation information (such as it not including temporary road works and diversions) are not used when analysing historical data.

Two examples of sensor data and the manner it is used to give performance indicators and training indicators are given below, in relation to the braking distance and the routine for use at junctions.

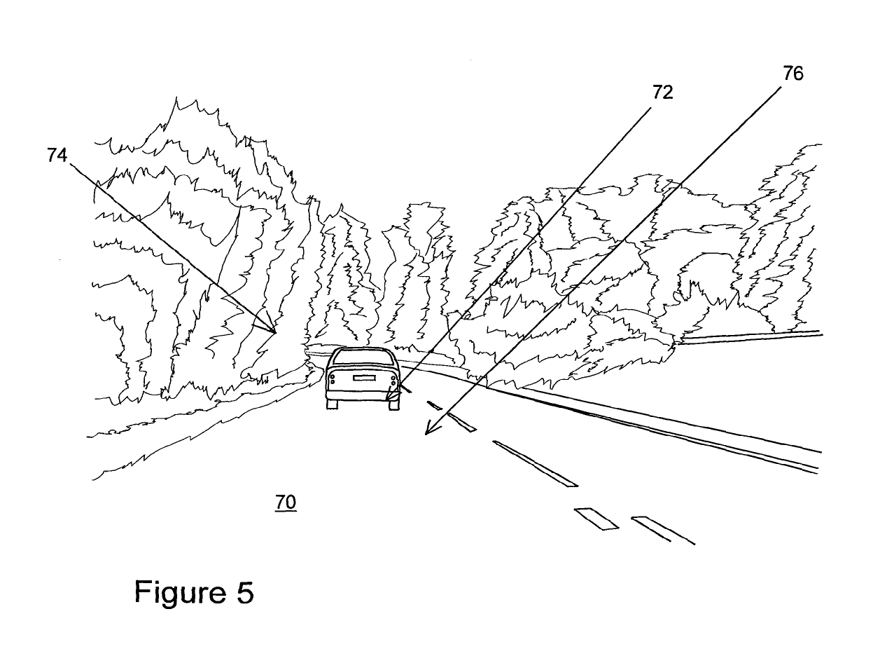

In FIG. 5 is shown an image 70 from the front facing camera 23. The image 70 includes a car 72 and scenery including a tree 74 and white line 76. Such objects can be identified within the image using known image processing techniques.

The front facing camera can be used to calculate the braking distance from the car 72 in front. Current driver training indicates that there should always be at least two seconds of travelling time between the motor car being driven and the one in front irrespective of the speed. In the UK this is colloquially known as “the two second rule” and is often memorised by repeating the phrase “only a fool breaks the two second rule”. The data in the form of images from the camera 23 can be used to calculate a performance factor of braking distance in terms of travelling time and in particular how this relates t the value of two seconds. By using processor 30 and software it is possible to calculate the distance between the driver's car and the car shown in front in the camera data in this case car 72. This could be calculated by determining the distance from the car (such as by assessing the size of the car 72 in the image or by counting white lines 76) and using data from the speedometer 20 to convert this dentine into travelling time. Alternatively multiple frames from camera 23 can be analysed to assess the rate of movement of scenery adjacent the car 72. For example the movement between frames of tree 74 or white line 76 can be analysed. The camera 23 may be set so that the point at which objects at the side of the road disappear from view is the point at which they are in line with the front of the driver's car. Accordingly the item taken from the scenery being adjacent the car 72 until it disappears from view is the braking distance in travelling time from the car in front. In another embodiment radar is used to calculate the distance.

This calculated travelling time can be displayed as a performance indicator or only displayed depending on whether it is above or below a threshold. For example it may only be displayed if it reduces below 2.5 seconds or 1.5 seconds. As indicated above the selection of threshold may depend on historical data. For example if a user is know to have problems following the “two second rule” a distance greater than two seconds (e.g. any distance less than three seconds) may be displayed to allow that user to be given advance indication that they should not get much closer. A driver known to nearly always keep to the rule may be told only when they break it. Additionally as indicated above the historical data from other sensors and performance factors may also be used in this determination. For example for a poor driver that needs great improvement in their gear selection it may be preferred for them to be able to focus on gear selection and displaying their braking distance every time they dip slightly under two seconds from the vehicle in front may detract them from this and impair their ability to learn and improve. A driver that is excellent and needs little extra training may benefit from a display for any infarction of the two second rule because they have little other information to be distracted by or to use to improve driving.

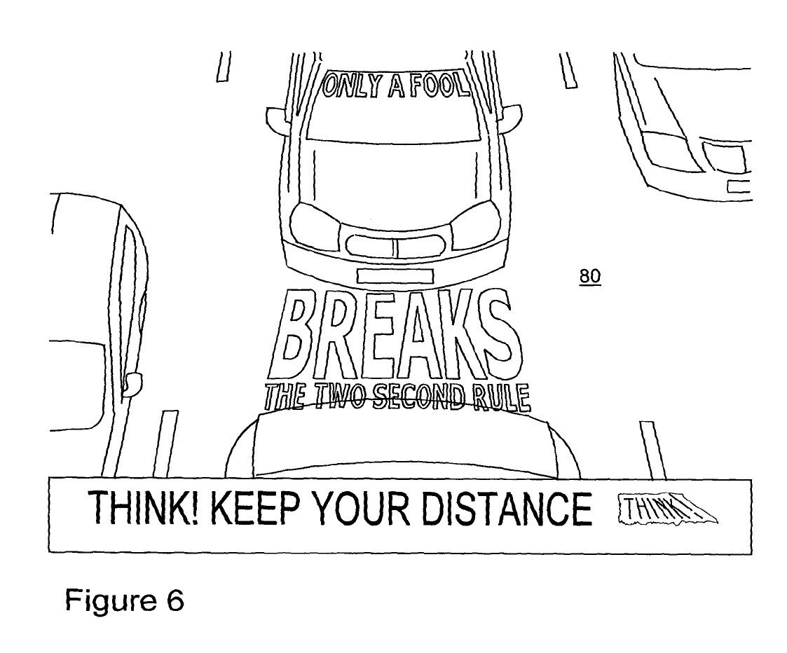

As well as a performance indicator relating to driving distance, training indicators both during and after driving may be chosen based on historical data of the drivers ability to judge braking distances well. For example a “tip of the day” screen may be shown as training data whenever the driver starts the engine. The image 80 shown in FIG. 6 from the UK government may be displayed for a driver who regularly breaks the two second rule whereas it would be of little use for a driver who appears not to break it.

The current guidance from the Institute of Advanced Motorists (RTM) is that on approaching a junction or roundabout drivers should follow a IPSGA routine which stands for Information, Position, Speed, Gear, Acceleration. By assessing navigation data of known road layout and GPS data of current location the system 8 can look for a driver to follow IPSGA at junctions and roundabouts. Relevant performance factors can be displayed or more prominently displayed before during and after navigating such junctions/roundabouts and historical data can be assessed to determine if IPGSA was correctly followed and this determination used to decide which performance factors and training information is shown in future. In terms of what can be measured by sensor array 12 of IPGSA this may include use and timing of headlight directions indicators before change of position, use of the steering wheel to reposition the car, information from the accelerometer 16 on when and by how much deceleration occurred, data from the gear indicator 17 on when a lower gear was selected and whether the driver changed down through multiple gears or whether they “block shifted” through multiple gears, when and at what rate the driver accelerated after the junctions/roundabout and when and to what gear they change up to.

Performance indicators that may be affected include the gear selection performance factor and training indicators that may be displayed based on historical data on IPSGA assessment include instruction on how to apply IPSGA and on block changing of gears.

Further example of performance factors are lane positioning (how far the vehicle is from the kerb/road centre) and consistency of road positioning e.g. whether the vehicle is meandering from left to right on a straight road. This are primarily assessed using the front facing camera 23 along with appropriate image processing software. When analysing historical information from the database 38 the prevalence of good and consistent lane positioning of the driver as with any other sensor data in database 28, can be taken into account when deciding which performance indicators are shown, their size and what training information is selected. Additionally occurrences of road meandering may be taken into account when deciding which other sensor information to use for weighting of performance indicators and/or training data. If a driver who is otherwise excellent at gear selection and acceleration appears to have a poor period of both gear selection and acceleration coinciding with rapidly changing road positioning then it may be decided that an unusual temporary event was likely responsible (such as distracting passengers) and that the other sensor data from this period of time should be given lesser consideration in evaluating the drivers ability to select gears.

The system 8 can preferably be used by multiple drivers. Each driver is identified such as by a password or fingerprint entered through the HMI 28. Sensor data stored in the databases are tagged with metadata describing the associated driver identified at the time or is stored in a location corresponding to that driver. Certain decisions based on historical data described above such as its use to determine which training information to show or which performance factors to show or the sizes of the indicators are then based primarily or only on historical data associated with the current identified driver. Other uses of the use of historical data described above such as its use to improve fuel consumption calculation may be vehicle rather than driver specific and therefore use historical data from several or all drives.

1. A feedback and training system for use in a vehicle:
the vehicle comprising or connected to one or more sensors enabled to measure one or more physical parameters associated with the vehicle; the system comprising:
a database, configured to receive and store data from the one or more sensors,
a processor enabled to calculate at least one performance factor based at least partly on the current physical parameters measured from the one or more sensors, and
a display configured to display to a driver representations of one or more of the performance factors,
wherein the prominence given to the display of the representation of a performance factor is dependent on historic sensor data stored in the database received previously from the sensors.

2. The system of claim 1
wherein the calculation of the performance factor, or a timing of the display of the representation, is dependent on historic sensor data stored in the database received previously from the sensors.

3. The system of claim 1 wherein at least one performance factor is primarily or wholly indicative of current vehicle performance.

4. The system of claim 1 wherein the processor determines the identity of the driver using the vehicle/system and the system is configured to store at least some of the sensor data in the database in a suitable location or with suitable metadata that it could be identified as being produced by a particular driver.

5. The system of claim 1 wherein the processor is enabled to calculate a plurality of different performance factors based at least partly on the current physical parameters measured from the one or more sensors,
the display configured to display to a driver representations of a plurality of the performance factors,
the processor configured to weight the relevance of a plurality of the performance factors based on the historic sensor data; and
wherein the prominence given to the display of the representation of a plurality of performance factors on the display is dependent on the relevance weighting of the plurality of performance factors.

6. The system of claim 5,
wherein the weighting of the relevance of a plurality of the performance factors comprises weighting the relevance to the currently identified driver, based on historic sensor data stored in the database identifiable as having been produced by the currently identified driver, and
wherein the prominence given to the display of the representation of a plurality of performance factors on the display, such as the determination of which performance factor representation should be displayed or displayed most prominently, is dependent on the determined weighted relevance to the currently identified driver.

7. The system of claim 1 wherein the prominence given to the display of the representation of a performance fact, or the calculation of a performance factor, or a timing of display of the performance factor, is dependent on prior journey historic sensor data stored in the database received from the sensors during previous journeys to the current measured physical parameters.

8. (canceled)

9. The system of claim 1 wherein the calculation of one or more performance factors uses one or more algorithms derived from data from a different vehicle to that connected to or comprising the sensors, with the current physical parameters measured from the one or more sensors being used as inputs into the algorithms.

10. The system of claim 1 wherein the calculation of one or more performance factors uses one or more algorithms derived from theoretical considerations, with the current physical parameters measured from the one or more sensors being used as inputs into the algorithms, based at least partly on the current physical parameters measured from the one or more sensors.

11. The system of claim 1 wherein the calculation of one or more performance factors uses one or more algorithms, and wherein at least one of the algorithms is modified based on the historic sensor data stored in the database, not the historic data used as inputs.

12. The system of claim 10 wherein the calculation of a performance factor, or the timing of or the prominence given to the display of the representation of a performance factor, is dependent on historic sensor data relating to the currently determined driver stored in the database received previously from the sensors and identifiable as having been produced by the currently identified driver.

13. The system of claim 10 wherein calculation of a performance factor, is dependent on historic sensor data stored in the database received previously from the sensors and identifiable as being produced by more than one determined driver.

14. The system of claim 1 wherein the processor is further enabled to calculate or select driver training data comprising instructions on how to use displays of performance factors or optimise the value of performance factors, based on the measured performance factor and a predetermined performance factor;
the system configured to display the calculated or selected training data on the display.

15. The system according to claim 14 wherein the database comprises a plurality of training data sets and the processor is configured to determine the relevancy of a plurality of different training data in the database, the relevance to the currently identified driver, and display the most relevant training data, wherein the relevancy is determined by one or more of: a current performance factor, historical sensor data produced by the currently identified driver, and occurrence of previous training data being displayed to the currently identified user.

16. (canceled)

17. (canceled)

18. (canceled)

19. The system of claim 1 wherein the physical parameters measured by the sensors are one or more of:
speed, acceleration, fuel level/use, engine revolutions, gear changes, throttle level, use of brakes, location information and distance behind the nearest different vehicle.

20. The system of claim 1 wherein the sensors comprise one or more of:
a speedometer, an accelerometer, a tachometer, a front facing camera, and a gps unit.

21. (canceled)

22. The system of claim 1 wherein the performance factors determined by the processor are one or more of:
fuel consumption, desirable top speed, desirable gear, rate of acceleration, rate of deceleration, distance from vehicle ahead.

23. The system of claim 1 wherein at least part of the database and/or the processor are stored outside of the vehicle and the system preferably comprises wireless communication means configured to send data from the sensors to the database.

24. (canceled)

25. (canceled)

26. (canceled)

27. (canceled)

28. (canceled)

29. A method of providing feedback and training in a vehicle, the method comprising:
using a processor to calculate at least one performance factor based at least partly on the current physical parameters measured by the one or more sensors in a vehicle configured to send data to be stored in a database,
and displaying to a driver of the vehicle representations of one or more of the performance factors,
wherein prominence given to the display of the representation of a performance factor or the calculation of a performance factor, or a timing of or the display, is dependent on historic sensor data stored in the database received previously from the sensors.

30. A non-transitory computer readable media containing instructions which when read by computer apparatus connected to vehicle containing sensors, and comprising a processor, execute a method of:
calculating, using a processor, at least one performance factor based at least partly on a current physical parameters as determined by one or more sensors in a vehicle, the sensors configured to send data to be stored in a database,
displaying, via display in the vehicle, to a driver of the vehicle representations of one or more of the performance factors,
wherein the prominence given to the display of the representation of a performance factor, or calculation of a performance factor, or a timing of or the prominence, is dependent on historic sensor data stored in the database received previously from the sensors.
